(19) United States
(12) Patent Application Publication
(10) Pub. No.: US 2014/0377147 A1
(43) Pub. Date: Dec. 25, 2014

(54) CHROMATOGRAPHY PIPETTE TIP

(71) Applicant: CyBio AG, Jena (DE)

(72) Inventors: Guenther SAMMLER, Jena (DE); Mario BUESCHEL, Milda (DE); Baerbel TAUTKUS, Rudolstadt (DE); Heidrun RHODE, Hainichen (DE); Sindy WENDLER, Apolda (DE)

(21) Appl. No.: 14/310,160

(22) Filed: Jun. 20, 2014

(30) Foreign Application Priority Data
Jun. 21, 2013 (DE) DE102013106534.1

(51) Int. Cl. B01L 3/02; B01D 15/22

(52) U.S. Cl. CPC B01L 3/0275; B01D 15/22
USPC 422/513

(57) ABSTRACT

Chromatography pipette tip having a first vessel and a second vessel which is open at two opposite ends and which, in each instance, has a bottom orifice via which a sample liquid can either be sucked in or expelled. The two vessels are fluidically and sealably connected to one another. A reaction matrix is arranged in one of the two vessels, through which reaction matrix the sample liquid is pushed by means of a pipettor to which the chromatography pipette tip is connected when used as intended. The sample liquid is drawn in and dispensed in opposite directions by the chromatography pipette tip and flows through the reaction matrix only in one direction.

### RELATED APPLICATIONS

The present application claims priority benefit of German Application No. DE 10 2013 106 534.1 filed on Jun. 21, 2013, the contents of which is incorporated by reference in its entirety.

### FIELD OF THE INVENTION

The invention is directed to a chromatography pipette tip such as is known generally in Utility Model DE 297 18 238 U1.

### BACKGROUND OF THE INVENTION

The concept of chromatography covers a large number of methods for the separation of sample constituents, e.g., macromolecules, ions, agglomerations, chelates, particles or combinations thereof, which are in the form of a solution or suspension in a liquid and form a mobile phase with the liquid. The basic principle behind all of these separation methods is that the mobile phase (referred to hereinafter as “sample liquid” for the sake of simplicity) is guided past or through a stationary phase. In so doing, interactions occur between the individual sample constituents and the stationary phase, which is referred to as “sample treatment”. Because of the varying intensity of the interactions of the individual sample constituents, the latter require different periods of time (retention times) to move past or through the stationary phase and can accordingly be captured successively in time. The intensity of the interactions may be influenced, for example, by the choice of process parameters such as temperature, pH of the sample liquid, the material composition thereof (e.g., aqueous solution and/or organic solvent, gas or gas mixture), pressure and implementation of the stationary phase (e.g., type of separation material, surface character, pore size, coatings, dimensioning and, therefore, separation path length for the sample liquid). At the present time, the separation methods are broadly applied in many configurations in research, analysis and production.

The separation processes can be carried out in one separation step, i.e., with the sample liquid flowing along or through the stationary phase once, or in a plurality of separation steps, i.e., with the sample liquid flowing along or through the same stationary phase or different stationary phase multiple times.

A cylindrical or conical vessel, also commonly referred to as a cartridge, hi which a reaction matrix formed by filling with separation material is inserted as stationary phase is used to carry out the separation processes. The diameter of the reaction matrix fits the cavity of the vessel and has a height which determines the length of the separation path through which the sample liquid flows in a separation step. In practice, the formed reaction matrix along with the vessel is referred to as a column.

The user has the option of either purchasing separation materials and vessel and completing the column herself or himself or obtaining ready-made columns. By “column” is meant within the meaning of the invention a vessel in which there is provided a reaction matrix which can be traversed by a sample liquid or through which a sample liquid can flow.

For many applications, columns are used which have a reaction matrix through which the sample liquid can flow in only one allowed direction (separation direction) so that sample liquid that has already been treated through the reaction matrix is prevented from mixing with sample liquid that has not yet been treated. The separation process can be operated through gravitational forces to cause a flow through the reaction matrix in the separation direction. In so doing, the sample liquid flows freely through the reaction matrix (free flow).

Particularly when the sample liquid runs through the reaction matrix due only to the earth's gravitational pull acting upon it, the problem may arise that individual volumes of sample liquid require different lengths of time to pass through a column when carrying out processes in parallel. Arrangements in which a plurality of volumes of sample liquid are treated in parallel by gravity, e.g., reaction matrixes are arranged in an array, frequently exhibit unreliable start-up, i.e., the sample liquid does not begin to flow through the respective reaction matrix at the same time, e.g., owing to wetting problems and disparate throughflow times (retention times) which can occur even as a result of very slight differences in the packing of the reaction matrixes (density, amount, spatial distribution of the separation material).

In experimental or diagnostic applications in which a plurality of identically handled volumes of a sample liquid are to be compared with each other or with a reference, retention times of varying length can lead to large variances in results, to errors or even to sample failures. Therefore, in order to incorporate arrangements of this kind in automated flows, laborious monitoring and, where necessary, correction are compulsory.

For this reason, an effort is made to standardize retention times in a predictable manner particularly for carrying out processes parallel in time.

It is known to propel the sample liquid through the reaction matrix by a centrifugal force many times greater than gravitational acceleration by means of a centrifuge in which the columns are inserted individually or in sets so as not to exceed a maximum retention time and so that a relatively large number of volumes of sample liquid can be separated parallel in time. This is generally applied in studies such as affinity separations and protein isolations (pull-down procedures) which could also be processed in batches. The use of pull-down methods of this kind is well suited to many analytic and (micro)preparative separation processes, preferably with only one separation step, owing to the low operating costs. A possible alteration in packing density and in the wetting of the reaction matrix resulting from the centrifugal forces and the high operating costs exclude repeated use in partial steps and particularly automated procedures.

It is also known to apply positive pressures or negative pressures to the columns and to cause a flow of the sample liquid through the columns by pressure differences by means of air displacement pipettors or positive displacement pipettors and piston pumps, also known as piston syringe pumps, or with high-pressure pumps in high-pressure liquid chromatography. Pressure differences of this type can be adjusted with high precision by these pipettors. In this way, the individual sample constituents can be separated in a very precise, reproducible manner. For this purpose, the columns can be constructed in the form of pipette tips and connected with pipettors in different ways.

A pipette tip is known from Utility Model DE 297 18 238 U1 in which it is referred to as a pipette. Generally, pipettes are metering aids or instruments in which a piston is guided within a cylinder so as to be sealed relative to the cylinder and an orifice is provided at the cylinder for receiving a pipette tip. By raising and lowering the piston manually or automatically, liquid can be drawn into the attached pipette tip but can also be drawn into and dispensed from a vessel in a manner comparable to a syringe.

A pipette tip disclosed in the above-cited Utility Model DE 297 18 238 U1 is provided in connection with a metering aid to filter liquids and may be referred to as a chromatography pipette tip within the meaning of the invention. In the intake and outlet area, the pipette tip is provided with closure means which are to be opened and with at least one filter element. The filter element is formed three-dimensionally and therefore has a height corresponding to a separation path length for a separation process. Accordingly, it constitutes a reaction matrix within the meaning of the invention. Together with the circumferential inner wall of the pipette tip, the closure means form a valve. The pipette tip performs the function of receiving liquids as well as the function of a reaction vessel in the manner of the columns described as prior art.

In the different embodiments of the described pipette tip, components of the pipette tip are themselves formed as filter element, or a filter element is inserted into the pipette tip, or the pipette tip is filled with filter material. In the embodiments in which intake and dispensing are carried out via the intake and dispensing area, liquid flows through, or at least flows against, the filter element substantially both when liquid is taken in and when liquid is dispensed and, therefore, in two opposed directions. In so doing, a comparatively large proportion of untreated liquid is dispensed again, or a comparatively large proportion of liquid is carried over from one separation step to the next separation step. In a further embodiment of the pipette tip, dispensing is not carried out via the intake and outlet area; therefore, this embodiment is not suitable for drawing in and dispensing one or more liquids multiple times from the same sample vessel or from identically designed sample vessels.

The pipette tip disclosed in the above-cited Utility Model DE 297 18 238 U1 is known as an air displacement pipette tip. This means that it is used in combination with metering aids operating by the principle of air displacement and is accordingly suitable for an individual air displacement pipette and for an array or matrix of air displacement pipettes or an air displacement multipipettor (referred to hereinafter collectively as air displacement pipettor).

A conventional air displacement pipette tip is generally formed by a conical vessel, which may also be partially cylindrical, with a free tip-shaped orifice at the end of the smaller cross section serving as intake and dispensing orifice (distal end) and with a mounting lip for attaching to a metering aid (proximal end), preferably of an air displacement multipipettor, at the end of the larger cross section. Multipipettors comprise a plurality of piston pumps arranged in a row or matrix with pistons guided in cylinders. By means of an identical quantity of pipette tips arranged in the same way as the piston pumps, liquid can then be alternately drawn into the pipette tip and then dispensed again in association with a piston pump through the tip-shaped orifice so that the transporting of the liquid in the pipette tip undergoes a change in direction. The volume of the liquid drawn in is less than the maximum intake volume of the pipette tip so that the liquid cannot penetrate into the cylinder of the piston pump, and there is always an air buffer between the liquid and the piston so that the liquid cannot come in contact with the piston pump. Accordingly, in an advantageous manner the piston pump and, therefore, the metering aid, do not become contaminated by the liquid taken in so that by means of a simple change of pipette tips, which are generally single-use (disposable) articles, the metering aid together with new pipette tips is immediately available for use with other liquids. Naturally, these articles can additionally be outfitted with aerosol filters which are well known for contamination-protected work with pipettes and serve as protective filters for protecting against unintentional overfilling. The compressibility of the relatively large air buffer, which also limits the maximum possible pressure by which the liquid can be expelled from the pipette tips, can be a drawback with regard to dispensing liquid in an exactly identical fashion via all of the pipette tips. Air displacement pipettors of this type have been used heretofore particularly for transferring and aliquoting liquids; for this purpose, only very small pressure differences are sufficient for most liquids.

In addition to air displacement pipettors, there are also positive displacement pipettors. These are used for dispensing particularly thick materials, e.g., gels, and in association with contamination-protected pipetting because they do not allow the sample liquid to enter the pipette. This is an alternative to working with the above-mentioned aerosol filters.

Positive displacement pipettors operate on the principle of liquid displacement. In this case, the liquid is taken into the cylinder of the piston pump, and no air buffer should be formed between the liquid and the piston as far as possible. Accordingly, compared to air displacement pipettors, liquid can be dispensed with better directionality, and this can also take place under appreciably higher pressure.

To prevent contamination of the pipettor, it is compulsory that pipette tips provided for this purpose, frequently referred to as syringes or cartridges in this case, are formed at least partially cylindrically, and a piston is guided in the cylindrical portion. In other words, the pipette tips themselves form the piston pumps in this case. Accordingly, the pipettor has one or more gripping or coupling mechanisms arranged in an array or matrix to connect the piston to the pipettor and to drive it. Accordingly, pipette tips for positive displacement pipettors are comparatively more complicated and, consequently, more expensive and are therefore used less often than pipette tips for air displacement pipettes for routine laboratory work.

Both of the common pipette tips mentioned above are basically unsuitable for applications in which a liquid may only run through the pipette tip in one flow direction; for this reason, they appear suitable for chromatography only under certain conditions if at all.

Nevertheless, as has already been stated, an attempt was made to use them for this purpose as disclosed in the above-cited Utility Model. It is also compulsory that the pipette tips described therein be filled from one side, preferably from the top, at least when a sample receptacle for holding the sample liquid and a sample receptacle for dispensing the sample liquid are to be arranged in the same relative position with respect to the pipette tips and particularly when the flow direction of the sample liquid through or past the reaction matrix may not be changed. In this case, in order to fill the pipette tips with sample liquid it is generally necessary to break a seal relative to the pipettor, which does not require only one additional work step. When generating and breaking the seal, very small tolerances cause undefined effects (e.g., a start-up of the column), and this may occur in a variety of ways over a number of columns, e.g., of an array or test series. Therefore, a highly precise, identical separation of the sample constituents is not possible when processes are carried out parallel in time.

If the separation process is to be carried out over a number of separation steps, the sample liquid must be added anew to the reaction matrixes for each separation step, which could require breaking the seal between the column and pipetting device each time, and the disadvantages which were described above can occur.

### SUMMARY OF THE INVENTION

It is an object of the invention to provide a chromatography pipette tip which allows sample liquid to be drawn into and dispensed from a vessel outfitted with a reaction matrix from identical sample receptacles and in which a liquid flows through the reaction matrix in only one direction.

This object is achieved for a chromatography pipette tip according to the invention having a first vessel and a reaction matrix for treatment of a sample liquid. The first vessel is a vessel which is open at two opposite ends, forms a cavity and has a first vessel axis, wherein a base surface is formed at one of the ends. Proceeding from the base surface, a first vessel channel is formed having a channel axis which extends parallel to the first vessel axis and which opens into a bottom orifice of the first vessel fluidically communicating with the environment.

An important feature of the invention is that the chromatography pipette tip also includes a second vessel, which is open at two ends, and which also has a vessel axis, i.e., the second vessel axis. The second vessel fluidically communicates with the environment below the reaction matrix via a bottom orifice of the second vessel. Above the reaction matrix, the second vessel fluidically communicates with the first vessel such that they can be sealed relative to one another via a top orifice.

In principle, the second vessel axis can extend along any course between the bottom orifice and top orifice of the second vessel. However, the second vessel axis is preferably arranged so as to extend parallel to the channel axis and, therefore, parallel to the first vessel axis so that the sample liquid can be received via one of the two vessels and dispensed again via the other of the two vessels in exactly opposite flow directions.

The reaction matrix is preferably arranged in the cavity within the first vessel, and the second vessel is formed by a tube. The second vessel is sealed relative to the first vessel by means of a first valve which is provided at the top orifice of the second vessel, the second vessel is used for intake and the first vessel is used for treating and dispensing a sample liquid.

The bottom orifice of the second vessel is advantageously arranged below the bottom orifice of the first vessel.

It is likewise advantageous to provide a second valve by means of which the first vessel channel can be sealed from the environment.

For producing as disposable articles, the first vessel and the second vessel are advantageously produced as an injection molded part.

It is very advantageous for handling when the first vessel channel coaxially surrounds the second vessel.

The second vessel can also be pot-shaped with a second vessel channel which is formed at a base of the pot and which opens into the bottom orifice of the second vessel. A second vessel of this kind is arranged within the cavity of the first vessel such that the second vessel axis coincides with the first vessel axis, and a coaxial intermediate space remains around the outer wall of the second vessel so as to completely enclose the outer wall. The reaction matrix is inserted into the second vessel in this case, and the first vessel is then used for receiving a sample liquid and the second vessel is used for treating and dispensing a sample liquid.

The second vessel can be lifted and lowered along the first vessel axis, and the outer wall of the second vessel can contact the bottom surface of the first vessel in a lower end position so that the remaining intermediate space is sealed from the environment. In this case, the bottom orifice of the second vessel can advantageously be arranged below the bottom orifice of the first vessel such that setting the bottom orifice of the second vessel upon a sample receptacle base can cause the second vessel to be lifted. The bottom orifice of the second vessel is accordingly closed at the same time by means of the sample receptacle base so that the chromatography pipette tip does not require additional means for sealing.

The end opposite the base surface can be closed by means of a piston which is guided in the cavity and which can be connected to a pipettor. Instead of this, an inner cone can be formed at the end opposite the base surface such that the chromatography pipette tip can be attached to a receiving cone of a pipettor; or a plane end face is formed so that the chromatography pipette tip can be arranged at a sealing plate of a pipettor.

A further advantage is when a collar is formed at the end opposite the base surface so that a plurality of chromatography pipette tips can be suspended in a magazine by means of the collar in order to be connected to a multipipettor.

### BRIEF DESCRIPTION OF THE DRAWINGS

The invention will be described more fully in the following by embodiment examples with reference to the drawings. In the annexed drawings:

FIG. 1a is a schematic diagram showing a side view of a first embodiment example in intake mode;

FIG. 1b is a schematic diagram showing a side view of the embodiment example according to FIG. 1a in dispensing mode;

FIG. 1c is a schematic diagram showing a bottom view of the embodiment example according to FIG. 1a;

FIG. 2a is a schematic diagram showing a side view of a second embodiment example in intake mode;

FIG. 2b is a schematic diagram showing a side view of the embodiment example according to FIG. 2a in dispensing mode;

FIG. 2c is a schematic diagram showing a bottom view of the embodiment example according to FIG. 2a;

FIG. 3a is a schematic diagram showing a side view of a third embodiment example in intake mode;

FIG. 3b is a schematic diagram showing a side view of the embodiment example according to FIG. 3a in dispensing mode;

FIG. 3c is a schematic diagram showing a bottom view of the embodiment example according to FIG. 3a;

FIG. 4a is a schematic diagram showing a side view of a fourth embodiment example in intake mode;

FIG. 4b is a schematic diagram showing a side view of the embodiment example according to FIG. 4a in dispensing mode;

FIG. 4c is a schematic diagram showing a bottom view of the embodiment example according to FIG. 4a;

FIG. 5a is a schematic diagram showing a side view of a fifth embodiment example in intake mode;

FIG. 5b is a schematic diagram showing a side view of the embodiment example according to FIG. 5a in dispensing mode;

FIG. 6a is a schematic diagram showing a side view of a sixth embodiment example in intake mode;

FIG. 6b is a schematic diagram showing a side view of the embodiment example according to FIG. 6a in dispensing mode;

FIG. 7a is the end of the first vessel opposite the base surface in a first embodiment;

FIG. 7b is the end of the first vessel opposite the base surface in a second embodiment;

FIG. 8a is a schematic diagram showing a side view of a seventh embodiment example in intake mode; and

FIG. 8b is a schematic diagram showing a side view of the embodiment example according to FIG. 8a in dispensing mode.

### DESCRIPTION OF THE EMBODIMENTS

A chromatography pipette tip according to the invention, i.e., a pipette tip which is provided for carrying out methods of chromatography in conjunction with metering aids such as pipettors, as can be seen in all of the schematic diagrams of the embodiment examples, basically has a first vessel 1 with a first vessel axis 1.1. Like conventional pipette tips, the first vessel 1 is preferably cylindrical, conical or has a combination of cylindrical and conical portions. It has a base surface 1.2 which is preferably conical and an end 1.3 which is located opposite the base surface and which serves as a mounting lip so that it can be connected with a metering aid. An elongate first vessel channel 1.4 with a channel axis 1.4.1 opening into a bottom orifice 1.5 of the first vessel is formed in the base surface 1.2. The bottom orifice 1.5 of the first vessel can preferably be sealed from the environment. The sealing is carried out by means of a second valve 4 in most of the embodiment examples described herein with the exception of the sixth embodiment. Sealing is not required when the fluidic resistance of the reaction matrix 5 (this will be discussed further) is greater than the fluidic resistance of the second vessel 2 (this will be discussed further) for a sample liquid to be drawn in. The fluidic resistance of the reaction matrix is determined particularly by its consistency. It can be, for example, in the form of a gel, granules or a sintered solid.

The first vessel 1 encloses a cavity 1.6 in which a reaction matrix 5 is directly inserted, e.g., between a lower frit 7.1 and an upper fit 7.2, in the first to third embodiment examples. In the fourth and fifth embodiment examples, the reaction matrix 5 is inserted into a second vessel 2 so that there is a switch in function between the first vessel 1 and the second vessel 2; that is, the sample liquid is received via the first vessel in one case and dispensed via the second vessel in the other case.

A chromatography pipette tip according to the invention basically has a second vessel 2 with a second vessel axis 2.3 and with a bottom orifice of the second vessel 2 and a top orifice 2.2 of the second vessel. This second vessel 2 is a tube, except in the fourth and fifth embodiment examples. It is preferably straight but can also be bent adjoining the bottom orifice of the second vessel 2.1. In the latter case, the axis of the tube portion adjoining the top orifice 2.2 of the second vessel is the second vessel axis 2.3. The tube can be rigid or flexible.

In the first and second embodiment examples, the tubular second vessel 2 is arranged inside the first vessel 1. However, in the third embodiment example the tubular second vessel 2 is produced outside the first vessel 1 and shares a vessel wall with the latter.

The second vessel 2 fluidically communicates with the cavity 1.6 and can be sealed off from it preferably at the top orifice 2.2 thereof. In all of the embodiment examples with the exception of the fifth embodiment example, this is carried out by means of a first valve 3 which is preferably arranged at least close to the bottom orifice 2.2 of the second vessel. The bottom orifice 2.1 of the second vessel is located below the base surface of the first vessel 1.2 and preferably protrudes over the bottom orifice 1.5 of the first vessel; that is, it is located at a greater distance from the base surface 1.2 than the bottom orifice 1.5 of the first vessel. Sample liquid can be drawn completely out of the sample receptacle without the bottom orifice 1.5 of the first vessel coming in contact with sample liquid in that the bottom orifice 2.1 of the second vessel lies below the bottom orifice 1.5 of the first vessel.

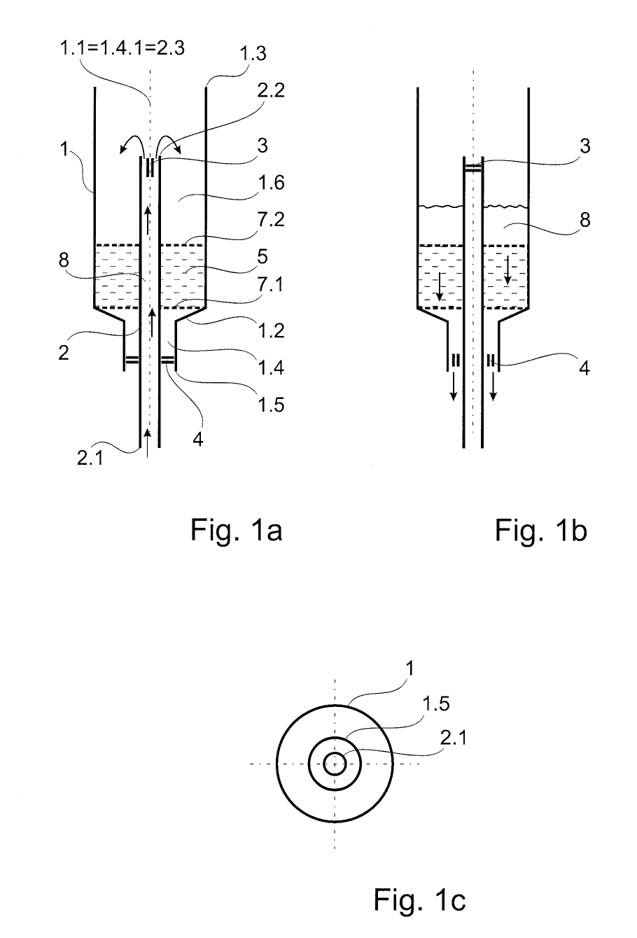

The basic manner of functioning of a chromatography pipette tip according to the invention will be explained in the following by way of example referring to FIGS. 1a and 1b.

The chromatography pipette tip functions only in connection with a metering aid by means of which a negative pressure and a positive pressure can be built up alternately in the cavity 1.6. Any conceivable metering aids such as those mentioned in the introductory part of the specification relating to prior art are suitable for this purpose. When a negative pressure is generated, a sample liquid is sucked out of a sample receptacle arranged under the latter via the second vessel 2, and when a positive pressure is generated this sample liquid is expelled through the reaction matrix 5 in the direction opposite to that in which it was drawn in. Accordingly, it is ensured that the sample liquid flows through the reaction matrix 5 in only one direction. In order to receive a sample liquid via the second vessel 2, the chromatography pipette tip is immersed in a sample receptacle with sample liquid so that the bottom orifice of the second vessel 2 is submerged below the surface of the liquid, but the bottom orifice 1.5 of the first vessel remains above the surface of the liquid. In so doing, the first valve 3 is open and the second valve 4 is closed so that the cavity 1.6 which is fitted to a pipettor so as to be sealed relative to it fluidically communicates with the environment only via the second vessel 2. In principle, the opening and closing of the two valves 3, 4 can take place either passively through the change in direction of an applied pressure or by means of active control depending on whether the valves are passive or active.

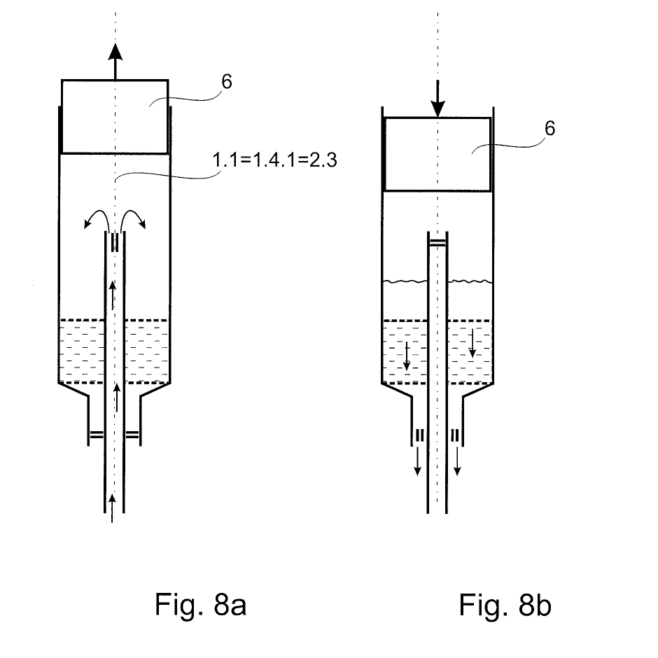

The first vessel 1 is closed at the end 1.3 opposite the base surface either by a piston 6 which is guided in the first vessel 1 (the first vessel 1 is then cylindrically shaped at least along a portion equal to the length by which the piston 6 is guided) as is shown in the seventh embodiment example referring to FIG. 8, or the end 1.3 opposite the base surface communicates, e.g., with a separate piston pump of an air displacement multipipettor in a sealed manner. By raising piston 6 or the piston of a separate piston pump, a negative pressure is formed in the cavity 1.6 so that sample liquid is compulsorily drawn in via the second vessel 2 provided that the lower end 2.1 thereof is immersed in a sample liquid. It then enters through the top orifice 2.2 of the second vessel into the cavity 1.6 and fills the latter to a point above the second frit 7.2, at most to a point below the top orifice 2.2. The first valve 3 is then closed and the second valve 4 is opened. As was already mentioned, this happens either by means of a control or through reversal of the direction of pressure by lowering the piston 6. Provided it has not yet been forced into the reaction matrix 5 by gravity and by the displacement of air in the direction of the cavity 1.6, the sample liquid located in the cavity 1.6 is now pushed though the upper fit 7.2, the reaction matrix 5 and the lower frit 7.1 and is dispensed via the bottom orifice 1.5.

Amid the large variety of possible embodiments, the chromatography pipette tips can be distinguished particularly by the arrangement of the second vessel 2 relative to the first vessel 1 and relative to the first vessel channel 1.4 thereof, by the construction of the valves 3, 4, by the relative position of the bottom orifice 1.5 with respect to the top orifice 2.1 of the second vessel and by the design of the end 1.3 opposite the base surface for connecting to a specific metering aid. In this respect, the various arrangement, construction and configuration of the vessels 1, 2 and, where present, of the valves 3, 4 can be combined with one another and are not limited to the embodiment examples described in the following.

They may differ and have greater or fewer advantages depending on the parameters following, e.g., from different sample receptacles from which the sample liquid is taken and dispensed, or on different volumes, temperatures or compositions of the sample liquid. Embodiments which can be produced cheaply as disposable articles are particularly advantageous.

Three different embodiment examples of chromatography pipette tips in which the first vessel 1 and the second vessel 2 in particular are arranged differently with respect to one another are shown in FIG. 1 to FIG. 3. The representations are limited to schematic diagrams which do not imply actual constructional embodiments, e.g., of the fastening of the second vessel 2 in or to the first vessel 1, or of the valves. Many known options are open to the person skilled in the art.

FIG. 1 shows a first embodiment example in which the channel axis 1.4.1 of the first vessel channel 1.4, the first vessel axis 1.1 and the second vessel axis 2.3 of the second vessel 2, formed here as a tube, coincide in a borderline case of parallelism. The second vessel 2 is coaxially surrounded by the first vessel channel 1.4 and protrudes from the latter. In order to fix the second vessel 2, the frits 7.1, 7.2 could have, e.g., a radially rigid ring structure or, in addition to the frits 7.1, 7.2, radially rigid ring structure elements could be provided in the cavity 1.6 in which the second vessel 2 is held. The sample liquid dispensed by the chromatography pipette tip runs along the surface of the portion of the second vessel 2 protruding from the first vessel channel 1.4 and is dispensed substantially along the first vessel axis 1.1. Accordingly, the sample liquid treated in the reaction matrix 5 flows over a surface which is still wetted with traces of untreated sample liquid, which can lead to contamination of the treated sample liquid. For handling sample receptacles with untreated sample liquid and treated sample liquid, it may be advantageous that the treated sample liquid is dispensed exactly into the position from which is was received.

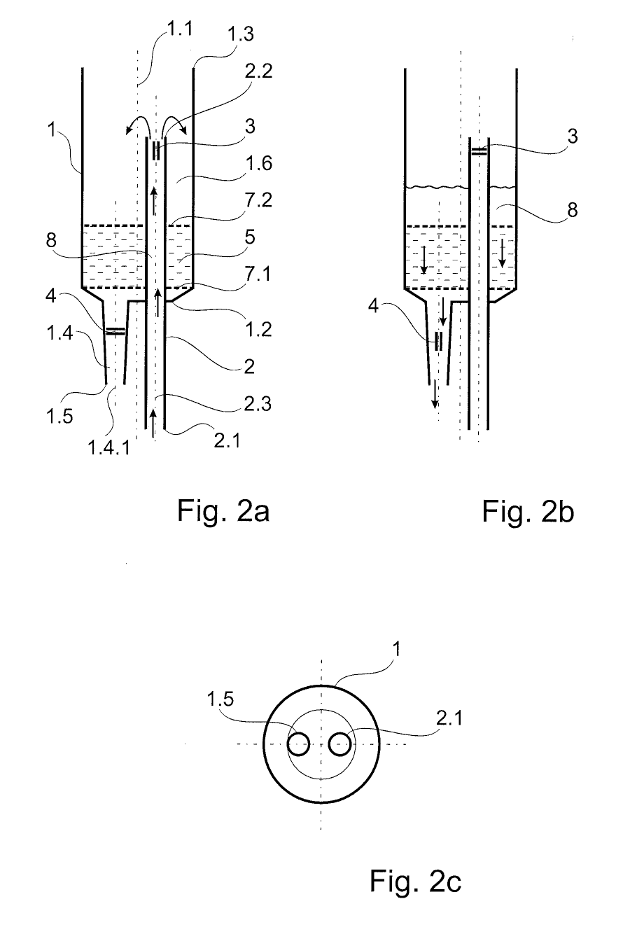

In the second embodiment example which is shown in FIG. 2, the second vessel 2 likewise projects into the first vessel 1, but not coaxially with respect to the first vessel channel 1.4; rather, it is arranged so as to be offset to the first vessel channel 1.4, and the channel axis 1.4.1 and second vessel axis 2.3 extend parallel to one another and to the first vessel axis 1.1. This solution has the advantage over the first embodiment example that the second vessel 2 is guided through the base surface 1.2 such that the second vessel 2 is mechanically fastened so that no additional means are required for this purpose. Beyond this, it is advantageous that the dispensed sample liquid does not come in contact with the surface of the second vessel 2. In this embodiment example, the first vessel 1 and the second vessel 2 can be produced together in one piece, e.g., by injection molding, which is already a proven method for large-series production of disposable articles such as pipette tips. Owing to the perpendicular gap between channel axis 1.4.1 and second vessel axis 2.3, it is possible to draw sample liquid from a sample receptacle with recesses arranged in a grid and to dispense sample liquid again into the latter when the selected distance between the center of the bottom orifice of the first vessel 1.5 and the center of the bottom orifice of the second vessel 2.1 is equal to the grid spacing. According to the second embodiment example, this center distance corresponds to the perpendicular gap between the channel axis 1.4.1 and the second vessel axis 2.3. The center distance can also be implemented in that the second vessel 2 is bent relative to the second vessel axis 2.3 toward the bottom orifice 2.1.

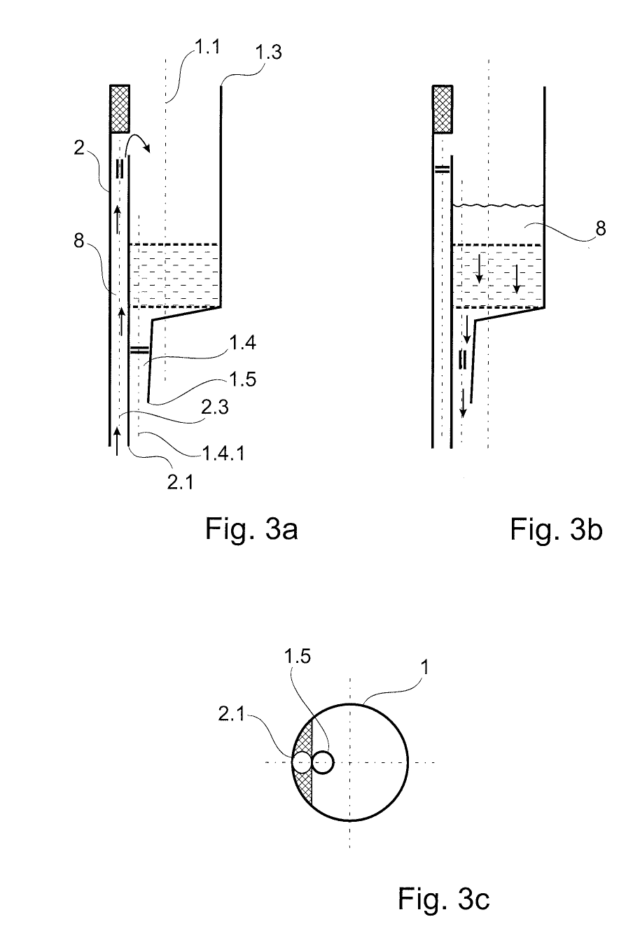

In the third embodiment example shown in FIG. 3, the second vessel 2 is located outside of the first vessel 1 and shares a portion of the vessel wall with it and is accordingly comparatively more stable.

Particularly in the embodiment examples shown above, it is not absolutely necessary that the second vessel axis 2.3 be arranged parallel to the first vessel axis 1.1. It is much more crucial that the two orifices of the second vessel 2.1, 2.2 are at different heights, specifically such that its top orifice 2.2 lies above the reaction matrix 5 and its bottom orifice 2.1 lies below the reaction matrix 5. The second vessel axis 2.3 can extend in essentially any shape therebetween, although a straight second vessel axis 2.3, particularly a second vessel axis 2.3 extending parallel to the first vessel axis 1.1, is advantageous already by reason of the short connection.

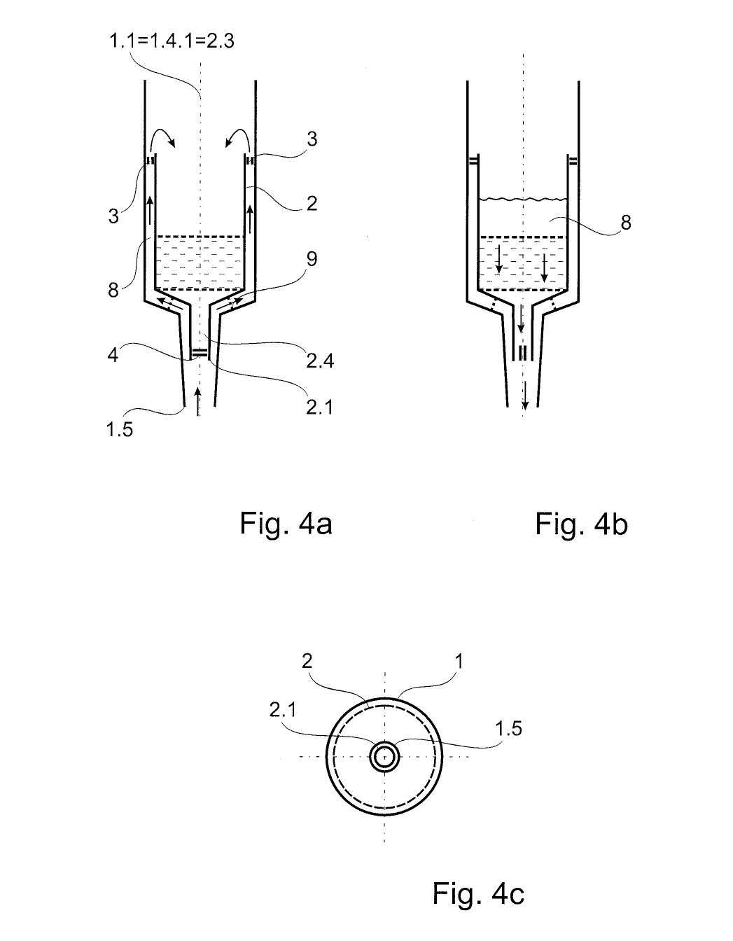

The fourth embodiment example, shown in FIG. 4, differs from the preceding embodiment examples particularly in that the second vessel 2 in this case is not a tube with a constant cross section, particularly a round cross section, but rather has a pot shape adjoined by a second vessel channel 2.4 in the shape of a tube. The pot shape of the second vessel 2 is adapted to the shape of the surrounding portion of the first vessel 1 such that an intermediate space is formed around the second vessel 2 with respect to the first vessel 1. The intermediate space can be secured, for example, by spacers 9 formed at points on the first vessel 1. The advantages of the first embodiment example, namely, intake and delivery at exactly the same location, and those of the second embodiment example in which the treated sample liquid dispensed from the bottom orifice of the first vessel 1.5 cannot come in contact with the surface of the second vessel 2, are combined to a considerable extent in that the bottom orifice of the second vessel 2.1 and the bottom orifice of the first vessel 1.5 are arranged coaxial to one another.

In the fourth embodiment example and in the fifth and sixth embodiment examples which will be described in the following, the two vessels 1, 2 are used in a functionally reversed manner compared to the embodiment examples described above. In particular, this leads to the possibility of reducing the number of valves as is shown in the fifth embodiment example or completely doing away with the valves as is shown in the sixth embodiment example.

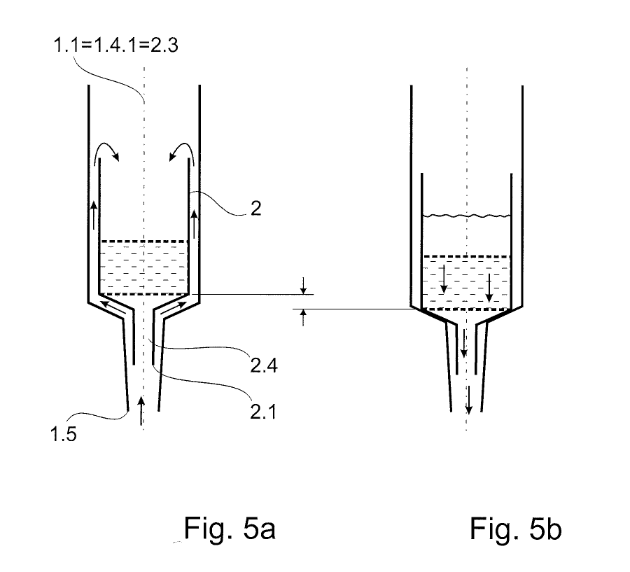

In a fifth, particularly advantageous embodiment example shown in FIG. 5, the second valve 4 can be omitted, whereas, in the embodiment examples mentioned above, this valve 4 is kept closed while the sample liquid is dispensed when the fluidic resistance of the reaction matrix 5 is greater than that of the enveloping intermediate space. In this case, the second vessel 2 is constructed and arranged identically to that in the fourth embodiment example, but without spacers 9 being provided between the base surface of the first vessel 1 and the second vessel 2; and it can be raised and lowered via a lift path a along the first vessel axis 1.1. When the second vessel 2 is raised to the maximum extent, an intermediate space completely surrounding the second vessel 2 is formed as in the fourth embodiment example and, in an analogous manner, sample liquid can be sucked up through this intermediate space which produces a fluidic connection between the cavity 1.6 and the environment. The lift along lift path a is actively controlled by motor in opposition to the force of gravity of the second vessel 2 which is filled with the reaction matrix 5. When lowered to the maximum extent, the second vessel 2 comes in contact with the bottom of the first vessel 1 so that the fluidic connection via the intermediate space is interrupted and the first vessel 1 is sealed off from the environment. A sealing ring formed by a rubberized coating, for example, is advantageously formed at the base of the first vessel 1.2. Accordingly, a first valve 3 which is otherwise provided for this purpose can be omitted.

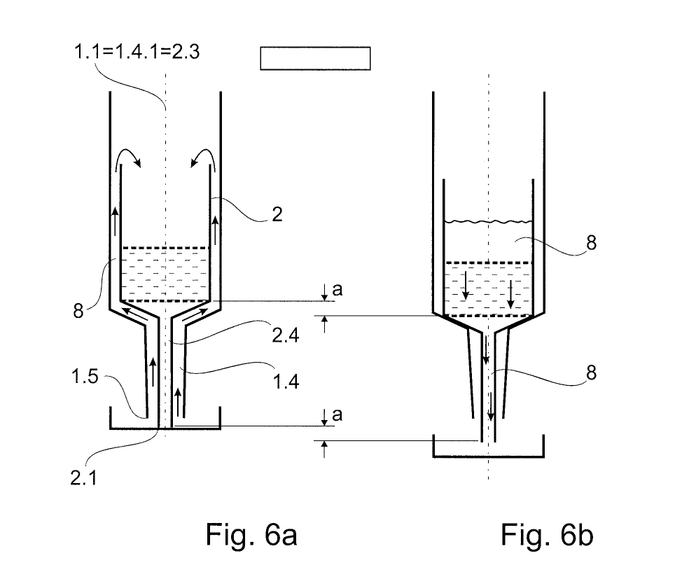

A chromatography pipette tip can be further simplified according to a sixth embodiment example shown in FIG. 6 in contrast to the fifth embodiment example when the second vessel channel 2.4 which is formed at the second vessel 2 and opens into the bottom orifice of the second vessel 2.1 projects through the first vessel channel 1.4, for example. When the chromatography pipette tip is inserted into a sample receptacle, the second vessel channel 2.4 is placed on the sample receptacle base, and the bottom orifice of the second vessel 2.1 is closed. A sealing lip is advantageously formed at the bottom orifice of the second vessel 2.1. As the chromatography pipette tip is lowered further, the second vessel 2.1 is raised relatively in the first vessel 1.4 and an intermediate space is formed according to the fifth embodiment example so that the sample liquid can be taken up through the first vessel channel 1.4. When the sample liquid has been completely drawn in, the sample receptacle and therefore the sample receptacle base are lowered relative to the bottom orifice of the second vessel 2.1, and the second vessel 2.1 is lowered relatively in the first vessel 1.4, the intermediate space closes analogous to the fifth embodiment example, and the bottom orifice of the second vessel 2.1 is released again. Before the sample liquid can exit from the bottom orifice of the second vessel 2.1 after flowing through the reaction matrix 5, a sample receptacle for dispensing the sample liquid, instead of the sample receptacle for receiving the sample liquid, is arranged relative to the chromatography pipette tip. In an advantageous manner, the second vessel 2 is raised and lowered in the first vessel 1 by motor in alignment with lift path a; however, this can also be carried out magnetically, for example, when magnetic particles are introduced into the material during production of the second vessel.

A chromatography pipette tip of this type accordingly needs no additional valves and can be assembled merely by inserting the second vessel 2 filled with the reaction matrix 5 into the first vessel 1. The two vessels 1, 2 can be produced as simple injection molded parts.

In further embodiment examples in which the valve function is performed by the two vessels themselves, channels could be formed or closed by rotating the vessels relative to one another, for example.

As was already mentioned, the first vessel 1 must be sealed at the end opposite the base surface 1.3 to build up a pressure that presses the sample liquid through the reaction matrix 5 so that the cavity 1.6 fluidically communicates with the environment only via the reaction matrix 5. This is carried out regardless of whether the sample liquid is located directly in the first vessel 1 or in the second vessel 2, in which case it is compulsory that the second vessel 2 is arranged inside the first vessel 1.

In principle, all of the embodiment examples of chromatography pipette tips described herein can be ready-made, i.e., can be delivered filled with a reaction matrix 5 or can be delivered without being filled so that they can be filled by the customer. Filling with a reaction matrix 5 is required in order to be used as intended.

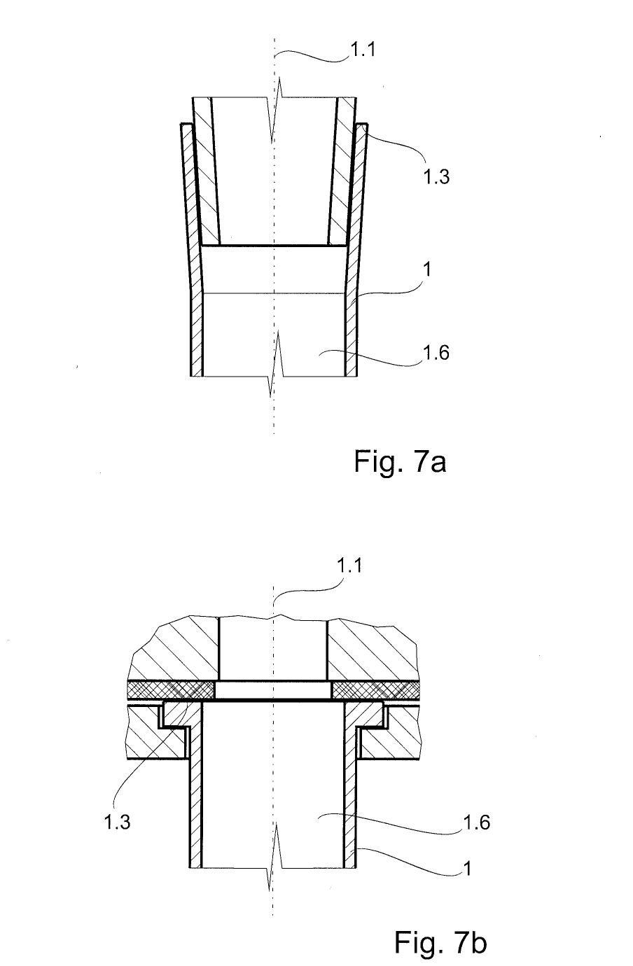

The embodiment examples described thus far are chromatography pipette tips which are intended for use with air displacement pipettes. For this purpose, the end 1.3 opposite the base surface is configured in such a way that it can be connected to a commercial multipipettor. A conical construction such as that shown in FIG. 7a is known for this purpose to attach the chromatography pipette tip to a receiving cone or, as is shown in FIG. 7b, a plane collar is formed for pressing against a sealing plate. It is also possible to seal the chromatography pipette tip relative to the multipipettor by a seal which surrounds the chromatography pipette tip externally.

All of the embodiment examples mentioned herein can be modified by supplementing with a piston 6 which is guided in the first vessel 1, which must then be formed at least partially cylindrically, so that the chromatography pipette tip can also be used for positive displacement pipettors. In this case, the chromatography pipette tip need not be arranged in a sealing manner at these pipettors, and a coupling, e.g., a gripping mechanism or snap-on mechanism, which does not act in a sealing manner can be sufficient for fastening.

FIG. 8 shows by way of example a seventh embodiment example of this kind which is based on the first embodiment example.

In principle, the chromatography pipette tip can be constructed as a hand pipette for manual operation provided that it is supplemented with a piston 6. In this case, the valves 3, 4 can be produced in a very simple manner, where appropriate, as pinch valves actuated by manual pressing when the first vessel channel 1.4 and the second vessel 2 are produced at least partially from a thermoplastic elastomer.

However, it is only when the chromatography pipette tip is used in connection with multipipettors that the advantages of the invention are fully brought to bear. In this way, chromatography can be carried out with high precision for a multitude of volumes of the same sample liquid or different sample liquids parallel in time and in a highly automated manner. For example, duckbill valves, mushroom valves, ball valves or a combination of valves of these types made from elastomer, rubber or TPE are advantageously used as passive valves. Externally driven, e.g., solenoid-operated, valves or the above-mentioned pinch valves are particularly suitable as active valves.

When the chromatography pipette tip is provided for operating in conjunction with a multipipettor, it can be advantageous when the second vessel axis 2.3 and the channel axis 1.4.1 do not exceed a certain distance relative to one another so that sample liquid can be drawn from a sample receptacle with a grid of recesses, e.g., 8×12, equal to the grid of piston pumps of a multipipettor and can be dispensed into another identical sample receptacle. To make this possible solely by a relative lifting movement of the pipette arrangement relative to the vessel arrangement, the distance of the channel axis 1.4.1 from the second vessel axis 2.3 must, if possible, be small enough to allow a chromatography pipette tip to dip into a recess positioned under it and to allow the same chromatography pipette tip to dispense the sample liquid into a recess of another sample receptacle, e.g., a microtiter plate, alternately arranged in the same position.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

### LIST OF REFERENCE NUMERALS

1 first vessel
1.1 first vessel axis
1.2 base surface of the first vessel
1.3 end opposite the base surface
1.4 first vessel channel
1.4.1 channel axis
1.5 bottom orifice of the first vessel
1.6 cavity
2 second vessel
2.1 bottom orifice of the second vessel
2.2 top orifice of the second vessel
2.3 second vessel axis
2.4 second vessel channel
3 first valve
4 second valve
5 reaction matrix
6 piston
7.1 bottom frit
7.2 top frit
8 sample liquid
9 spacer
a lift path

What is claimed is:

1. A chromatography pipette tip comprising a first vessel which is open at two opposite ends, said first vessel having a cavity and a first vessel axis, a base surface being formed at one of said ends, a first vessel channel formed in part by said base surface and having a channel axis, said channel axis extending parallel to the first vessel axis, said first vessel channel opening into a bottom orifice of the first vessel fluidly communicating with the environment, a reaction matrix within said cavity for treatment of a sample liquid, a second vessel open at two ends having a second vessel axis, said second vessel having a bottom orifice below the reaction matrix that fluidly communicates with the environment, and a top orifice by which the second vessel fluidly communicates with the first vessel above the reaction matrix such that they can be sealed relative to one another.

2. The chromatography pipette tip according to claim 1, wherein said second vessel axis is arranged so as to extend parallel to said channel axis and, therefore, parallel to said first vessel axis.

3. The chromatography pipette tip according to claim 1, wherein said reaction matrix is arranged in the cavity below said top orifice of the second vessel, the second vessel being formed by a tube, and the second vessel being sealed relative to the first vessel by means of a first valve which is provided at the top orifice of the second vessel, wherein the second vessel is used for intake and the first vessel is used for treating and dispensing a sample liquid.

4. The chromatography pipette tip according to claim 3, wherein said bottom orifice of the second vessel is arranged below the bottom orifice of the first vessel.

5. The chromatography pipette tip according to claim 1, further comprising a second valve by means of which the first vessel channel can be sealed from the environment.

6. The chromatography pipette tip according to claim 1, wherein said the first and second vessels are produced as an injection molded part.

7. The chromatography pipette tip according to claim 2, wherein said first vessel channel coaxially surrounds said second vessel.

8. The chromatography pipette tip according to claim 2, wherein said second vessel is pot-shaped with a second vessel channel formed at a base of the pot and which opens into the bottom orifice of the second vessel and is arranged within the cavity of the first vessel, the second vessel axis coincides with the first vessel axis, and a coaxial intermediate space remains around the outer wall of the second vessel so as to completely enclose the outer wall, and the reaction matrix is inserted into the second vessel, wherein the first vessel is used for receiving a sample liquid and the second vessel is used for treating and dispensing a sample liquid.

9. The chromatography pipette tip according to claim 8, wherein said second vessel can be lifted and lowered along the first vessel axis, and the outer wall of the second vessel contacts the bottom surface of the first vessel in a lower end position so that the remaining intermediate space is sealed from the environment.

10. The chromatography pipette tip according to claim 9, wherein said bottom orifice of the second vessel is arranged below the bottom orifice of the first vessel, and setting the bottom orifice of the second vessel upon a sample receptacle base causes the second vessel to be lifted so that the bottom orifice of the second vessel is closed at the same time by the sample receptacle base so that the chromatography pipette tip does not require additional means for sealing.

11. The chromatography pipette tip according to claim 1, wherein said end opposite said base surface is closed by a piston which is guided in the cavity and which can be connected to a pipettor.

12. The chromatography pipette tip according to claim 1, further comprising an inner cone formed at the end opposite the base surface such that the chromatography pipette tip can be attached to a receiving cone of a pipettor.

13. The chromatography pipette tip according to claim 1, wherein a plane end face is formed at the end opposite the base surface such that the chromatography pipette tip can be arranged at a sealing plate of a pipettor.

14. The chromatography pipette tip according to claim 12, further comprising a collar formed at the end opposite the base surface so that a plurality of chromatography pipette tips can be suspended in a magazine by means of the collar in order to be connected to a multipipettor.
